(19) United States
(12) Patent Application Publication
(10) Pub. No.: US 2006/0004836 A1
(43) Pub. Date: Jan. 5, 2006

(54) Dynamic forms generation

(75) Inventor: Pankaj Dhingra, Sammamish, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 10/882,122

(22) Filed: Jun. 30, 2004

(51) Int. Cl. G06F 17/00

(52) U.S. Cl. 707/102

(57) ABSTRACT

To facilitate the localization of an OUTLOOK form, a custom form generator may be provided. More particularly, a facsimile form may be created in an application development environment to have the look and feel of the desired resulting OUTLOOK form. Selected controls in the facsimile form may be indicated as an existing OUTLOOK control in a basis or comparison OUTLOOK form. The properties of the controls of the facsimile form may be stored in a data store and a control binding identifier may be stored in an entity attribute map. The facsimile form and/or the binding descriptive names may be localized into the desired languages/cultures. A custom form generator may compare the localized facsimile form and associated entity attribute map with a basis localized OUTLOOK form to generate a custom OUTLOOK form.

### CROSS-REFERENCE TO RELATED APPLICATIONS

Reference is hereby made to the following co-pending and commonly assigned patent applications all filed on Jun. 3, 2004: U.S. application Ser. No. 10/860,226 entitled “METHOD AND APPARATUS FOR GENERATING FORMS USING FORM TYPES”, and U.S. application Ser. No. 10/860,225 entitled “METHOD AND APPARATUS FOR MAPPING A DATA MODEL TO A USER INTERFACE MODEL”, U.S. application Ser. No. 10/860,306 entitled “METHOD AND APPARATUS FOR GENERATING USER INTERFACES BASED UPON AUTOMATION WITH FULL FLEXIBILITY”, all of which are incorporated by reference in their entirety.

### FIELD OF THE INVENTION

This application is directed to dynamically generating forms, and more particularly, to generating forms compatible with MICROSOFT® OUTLOOK®.

### BACKGROUND OF THE INVENTION

The MICROSOFT® OUTLOOK® program is a workgroup personal information management program published by Microsoft Corporation, Redmond, Wash. Briefly described, the OUTLOOK® program allows users to manage their own calendar, messages, tasks, notes, and contacts and to share this information with others. Like many personal information managers, the OUTLOOK® program receives and displays relevant information through forms.

Generally, a form is a viewer for information such as a message, contact, business opportunity, and the like. MICROSOFT® OUTLOOK® provides standard forms as well as a design environment allowing users and developers to customize forms to meet requirements not provided by the standard forms. A detailed description of customizing forms in MICROSOFT® OUTLOOK® is incorporated herewith by reference and may be found in the Microsoft Developers Network Library under the title Jacob, et al., “Developing Custom Forms Using Microsoft Outlook 2002 (Part 1 of 2) and (part 2 of 2). These references are also cited with the Information Disclosure statement filed herewith.

When developing forms that will be used by multiple users, a form is typically localized, or in other words, modified to address the culture of the intended user of the form. For example, localization of a form may modify the form to accommodate differences in language, currency, calendar, time, and culture sensitive color and messages. As a result, a developer localizing a form may modify not only the labels of fields within a form, but also may modify the fields themselves.

### SUMMARY OF THE INVENTION

The following presents a simplified summary of the disclosure in order to provide a basic understanding to the reader. This summary is not an exhaustive or limiting overview of the disclosure. The summary is not provided to identify key and, or critical elements of the invention, delineate the scope of the invention, or limit the scope of the invention in any way. Its sole purpose is to present some of the concepts disclosed in a simplified form, as an introduction to the more detailed description that is presented later.

Although MICROSOFT® OUTLOOK® (hereinafter OUTLOOK) provides a design environment, it does not as yet provide a localization support component. As a result, a developer generating a custom form must manually modify the original form to generate a localized form. For example, a developer may manually change the form by localizing the labels, resizing fields to accommodate information from other languages, and change the location of fields. Moreover, the developer must manually bind the control of the form with the localized MAPI property.

To facilitate the localization of an OUTLOOK form, a custom form generator may be provided. More particularly, a facsimile form may be created in an application development environment, such as a MICROSOFT® WINDOWS® form (hereinafter Windows Form) template. The facsimile form has the look and feel of the desired resulting OUTLOOK form, e.g., comprises a plurality of controls with a selected control bound to a field in the underlying item. Moreover, selected controls in the facsimile form may be indicated as an existing OUTLOOK control on a basis or comparison OUTLOOK form. The properties of the controls of the facsimile form may be stored in a data store and control binding may be stored in an entity attribute map. The facsimile form may then be given to a localizer to localize the form into the desired languages/cultures. The localizer may translate the labels, may modify the presentation of the control of the facsimile form, and/or may translate the descriptive names of the binding properties in the entity attribute map. Each localizer may use the same original facsimile form, and each localizer may produce a localized facsimile form, such as a Windows Form template.

A custom form generator may compare the localized facsimile form and associated entity attribute map with a basis localized OUTLOOK form. The custom form tool may determine which controls of the standard localized OUTLOOK form exist within the localized facsimile form, which of these controls have been modified in their presentation on the localized facsimile form, and determine which controls are new in the localized facsimile form as compared to the basis OUTLOOK form. In this manner, the custom form tool may modify the basis OUTLOOK form to match the presentation and intended function of the localized facsimile form, e.g., generate a localized custom OUTLOOK form with its associated metadata. In this manner, the localization process may be completed within the application development environment such as a .NET environment, with its associated tools and environment. Moreover, the localization process may be simplified since the bindings of controls are not modified during localization.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an example system useful for implementing an embodiment of the present invention;

FIG. 2 is a schematic diagram of a localization process of a custom form in one embodiment of the invention;

FIG. 3 is an example facsimile form of the process shown in FIG. 2;

FIG. 4 is a flow chart illustrating an example process for generating a localized custom OUTLOOK form of FIG. 2; and

FIG. 5 is an example basis OUTLOOK form of FIG. 2.

### DETAILED DESCRIPTION

Computer System Environment

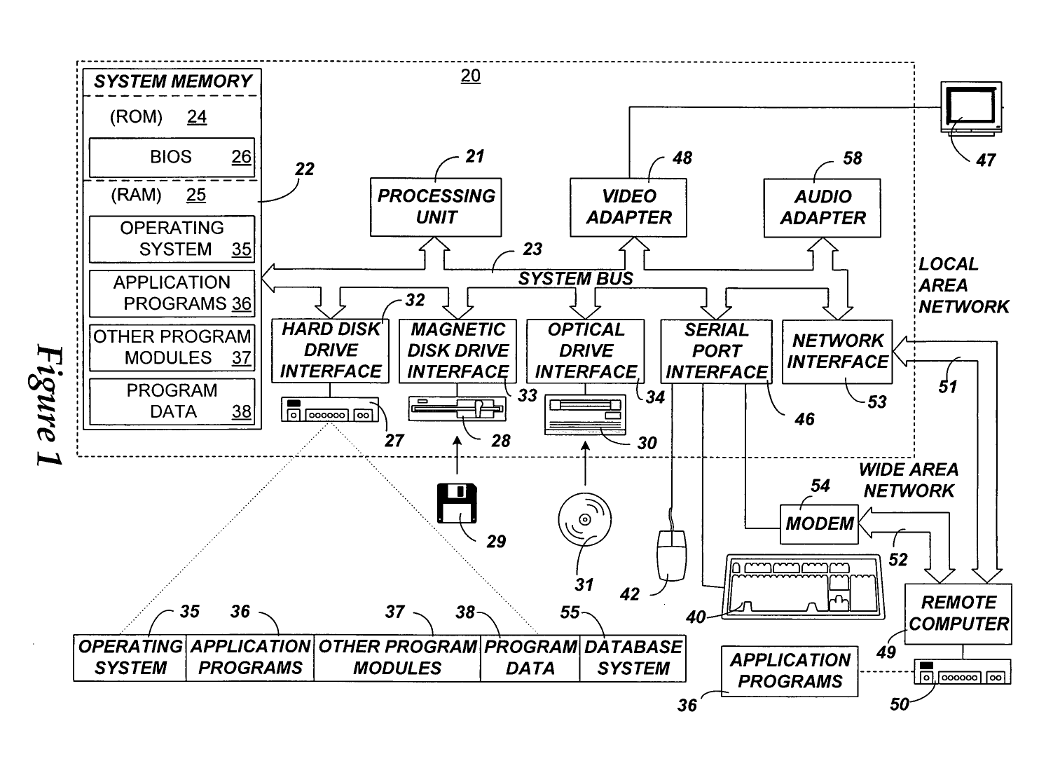

FIG. 1 illustrates an example of a suitable computing system environment 900 on which any combination of the localizer application 120, custom form generator 150, facsimile form 110, localized facsimile form 140, 142, and entity attribute maps 112, 144, 146, (discussed further below) may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 1 illustrates operating system 934, application programs 935, other program modules 936, and program data 937.

The computer 910 may also include other removable/non-removable, volatile/nonvolatile computer storage media. By way of example only, FIG. 1 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 1, provide storage of computer readable instructions, data structures, program modules and other data for the computer 910. In FIG. 1, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. Although the OUTLOOK application is designed to operate in conjunction with the MICROSOFT® WINDOWS® family of operating systems, is should be understood that the OUTLOOK application may be implemented in other operating systems such as Microsoft Corporation's OS/2® operating system and the operating system used in MACINTOSH® computers manufactured by Apple Computer, Inc.

A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through a output peripheral interface 990.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 1. The logical connections depicted in FIG. 1 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 1 illustrates remote application programs 985 as residing on memory device 981. It will be appreciated that the network connections shown are exemplary and other means of establishing a communications link between the computers may be used.

MAPI Architecture

The primary interaction between the OUTLOOK application and the operating system 944 of FIG. 1 involves messaging related tasks, and may incorporate Messaging Application Programming Interface (MAPI). The MAPI architecture is designed to facilitate programmer writing messaging-enabled applications that are independent of the underlying messaging system. MAPI provides high-level function that can be used to implement sophisticated messaging features.

Messages are created and displayed using forms that are appropriate for the specific type and/or class of message. Example, message classes or forms may include mail message, post, contact, distribution list, task, appointment, meeting request, note, journal entry and any other suitable message class. Although the following embodiments are described using examples from the contact class of messages, it should be appreciated that any other suitable message class may be implemented.

Items and Forms

An item is an actual message or item in a folder, whether it is a task, contact, or the like. In MAPI, an item is called a message, regardless of the OUTLOOK item type. An item, like a database, stores the information in a set of fields. Some examples of standard items within the OUTLOOK application include post, contact, distribution list, task, appointment, meeting request, note, and journal entry. Each type of OUTLOOK item has a standard set of fields for that type of item, i.e., standard OUTLOOK fields. In other words, an item is a container for information stored in the fields. Each OUTLOOK item type has a standard stet of fields associated with it. The standard fields for a particular type of item may be viewed by selecting All Fields in the Field Chooser dialog box when a form is opened in design mode. Some standard fields include attachments, Bcc, cc, contacts, created, and the like.

A form, on the other hand, is the user interface or front end to an item in the folder. It is typically made up of various controls that are used to allow a user to input information into as well as display information that is stored in the underlying fields within the item. Thus, a form is a viewing mechanism which displays information stored within the fields of a particular item.

A control may have many different controls including pages, tabs, passive controls, and active controls. For example, active controls accept input from the user and may include, MultiPage, TabStrip, Recipient, Message, Container, TextBox, ListBox, ComboBox, OptionButton, and the like. Static fields may include Label, Image, and the like. Active controls must be bound the appropriate field of the underlying item to preserve that information for later display of the item through the form. Passive controls, because they are static, do not require a binding to a field; however, passive controls may be bound to display the information in the underlying field to the user, although the user is not allowed to change the information in the field. In this manner, each active and selected passive control of a form may be bound to the corresponding field of the underlying item to ensure that the form will display the information that is stored in that item. The mapping of a control to a field may be one to one, many controls to one field, and/or one control to many fields.

In OUTLOOK, each control has a variety of properties which may be set to determine the characteristics of the control including a field of an item and presentation of a control. OUTLOOK properties of a control may indicate the descriptive name, the position, the font, the foreground color, the background color, the setting (visible, enabled, read only, resize with form, sunken, and multi-line) and the like. The properties of the control may also indicate the binding of the control to a field of the underlying item, generally through the Value property, although it is to be appreciated that any suitable property may be used to bind the control to the appropriate field. The properties of a control of an OUTLOOK form may be stored in a MAPI data store which is an object oriented database.

Customize

Although a user may use any form to view the contents of any item, the form may be customized to display the information of the underlying item in any way desired by the user. To customize a form, the OUTLOOK application provides a custom form design environment, or a user may provide an OUTLOOK compatible form in the accepted oft format. One exemplary reference discussing VBScript and .oft formats for OUTLOOK forms is the VBScript User's Guide, which is published by Microsoft Corporation, and which is incorporated herein by reference. A user may also modify or add custom fields which may be bound to a control, may delete/add controls, and/or may modify the presentation of the controls.

However, localizing an OUTLOOK form typically requires that the complete design process be completed for each form, e.g., that a form be opened in the OUTLOOK design environment, controls added/deleted and bound to the appropriate field if custom fields and/or controls from the OUTLOOK Control Toolbox are used. When localizing a form into various languages, this process may become expensive and prone to errors, particularly if custom fields and/or custom controls are used.

Facsimile Form

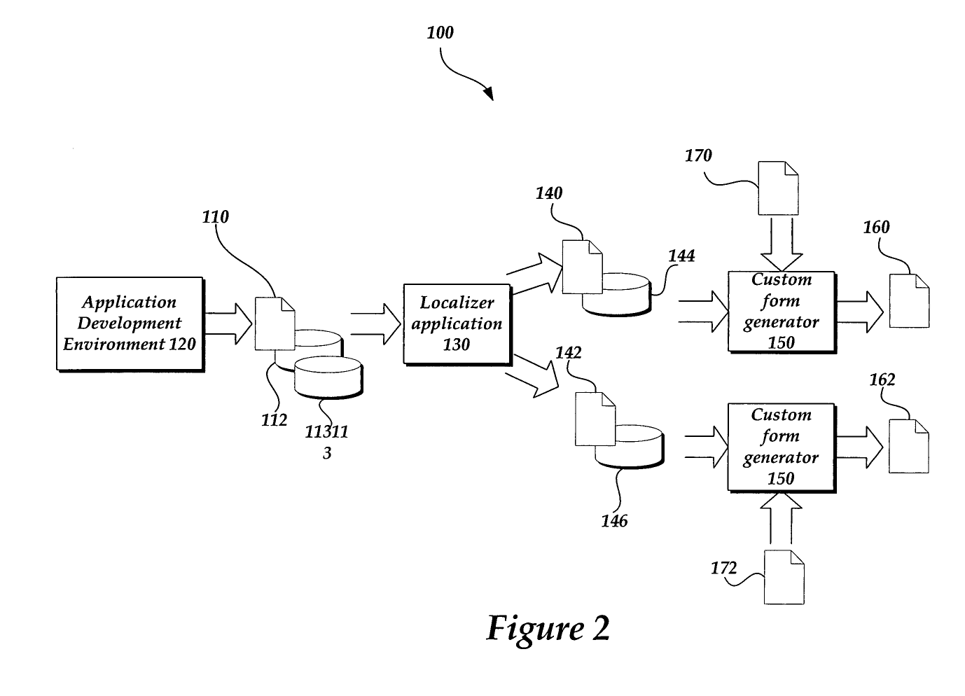

FIG. 2 illustrates a custom form process 100 which facilitates localizing forms compatible with the OUTLOOK application. Initially, a form designer creates a facsimile form 110 in an application development environment 120, rather than in the design mode of the OUTLOOK application. Any suitable application development environment 120 may be used to create the facsimile form, including VISUAL STUDIO of the Microsoft Corporation of Redmond, Wash., which may be used to create the facsimile form as a Windows Form template and any other suitable integrated and/or application development environment.

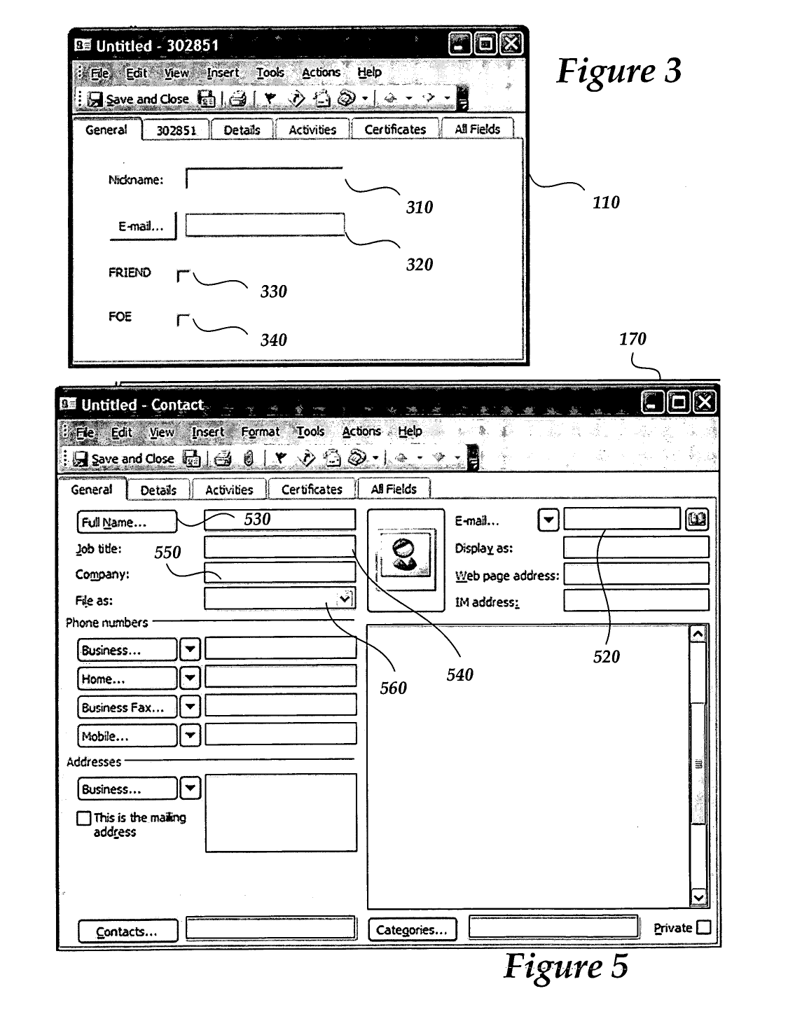

The facsimile form 110 may be created to have the same ‘look and feel’ or presentation as the desired OUTLOOK form. The facsimile form may be generated by laying out any number and type of controls as desired in the resulting form to be used. FIG. 3 illustrates an example facsimile form, which includes a Nickname TextBox control 310, an email TextBox control 320, a friend CheckBox control 340, and a foe control CheckBox 350. However, since the facsimile form is in a the format of the application development environment (such as the .NET format), it alone is not compatible with the OUTLOOK personal information management program.

The presentation and other properties of each control may be stored in any appropriate format such as in a data store or metadata associated with the form. For example, the location, font, and other presentation properties of the control may be stored in metadata associated with the facsimile form, such as in a resource file 113 as shown in FIG. 2. The resource file 113 may be a database of the MAPI properties associated with each control and may be stored on any type of server, such as a SQL server. Other storage mechanisms may also be used such as metadata within the form itself, and any other suitable data store.

To ensure that the information entered by a user into a control will be retained in an item, any number of the controls may be bound to or associated with an appropriate field of the underlying item. The binding property may be stored with the other MAPI properties of the control. Additionally or alternatively, the binding information may be stored in any appropriate format such as in a data store or metadata associated with the facsimile form. For example, the binding property for each field may be stored in an entity attribute map 112 associated with the facsimile form. The entity attribute map 112 may be a database associating the MAPI property identifier with the MAPI property name for the bound controls of the facsimile form. Examples of the entity attribute map and its mapping properties are described further in the following co-pending and commonly assigned patent applications all filed on Jun. 3, 2004: U.S. application Ser. No. 10/860,226 entitled “METHOD AND APPARATUS FOR GENERATING FORMS USING FORM TYPES”, and U.S. application Ser. No. 10/860,225 entitled “METHOD AND APPARATUS FOR MAPPING A DATA MODEL TO A USER INTERFACE MODEL”, U.S. application Ser. No. 10/860,306 entitled “METHOD AND APPARATUS FOR GENERATING USER INTERFACES BASED UPON AUTOMATION WITH FULL FLEXIBILITY”, all of which are incorporated by reference in their entirety.

In one example, the metadata associated with a facsimile form may include a binding property identifier for a particular control. More specifically, the MAPI property identifier may be 110 for a control labeled $foobar$. The associated entity attribute map 112 may associate the MAPI property identifier 110 with a MAPI property name which indicates the actual underlying field to be the $foo$bar$$.

OUTLOOK Indicator

The properties of a control of the facsimile form 110 may also include an OUTLOOK indicator which may be stored in any appropriate format such as in a database file or metadata associated with the facsimile form. For example, the OUTLOOK indicator for each control may be stored in the metadata stored in a resource file 113 associated with a facsimile form. The OUTLOOK indicator may identify if the control is an OUTLOOK control existing in a selected basis OUTLOOK form, or if the control is a control that does not exist in the selected basis OUTLOOK form. If the control is an existing OUTLOOK control, the OUTLOOK indicator may indicate which particular OUTLOOK control should be associated with the control of the facsimile form.

The facsimile form 110 shown in FIG. 3 illustrates a nickname control 310. The properties of the email control 320 stored in the facsimile form metadata may include an OUTLOOK indicator having the value of ‘email’ indicating that the control 320 is associated with the available OUTLOOK control of ‘email.’ However, the friend control 330 and the foe control 340 are not available controls through OUTLOOK, e.g., they are controls associated with custom fields of the underlying item. As a result, the controls 330 and 340 may each or collectively have a property of an OUTLOOK indicator indicating that these are new controls, e.g., have an OUTLOOK indicator value of ‘new’.

Localization

When the facsimile form 110 is created to have the desired presentation of an OUTLOOK form and the appropriate properties associated with the controls, e.g., through the entity attribute map 112 and resource file 113, the facsimile form 110 may be given to a localizer to localize the facsimile form as shown in FIG. 2. The localizer may receive the facsimile form, such as in a Windows Form template, and may modify the facsimile form to create a localized facsimile form addressing the culture and/or customs of the intended individual for the resulting OUTLOOK form. The facsimile form may be localized into any number of languages/cultures forming multiple localized facsimile forms. For example, as shown in FIG. 2, the localizer may modify the facsimile form 110 to create localized facsimile form 140, and another or the same localizer may modify facsimile form 110 to create localized facsimile form 142. If the facsimile form 110 is generated in the application development environment 120 in the intended language, then the localizer may be skipped, and the localized facsimile form 140 is the facsimile form 110. The localizer may use any appropriate application 130 to modify the facsimile form and/or entity attribute map including Visual Studio, LOC-STUDIO, ESPRESSO, and WINRES.EXE, all available from Microsoft Corporation of Redmond, Wash., and CATALYST available from Alchemy Software Development Ltd, of Dublin, Ireland.

To localize the facsimile form 110, the person localizing the facsimile form may use the localizer application 130 to translate the labels of each control to another language. The localizer application may provide an environment to manually change the facsimile form and/or to automate or assist translation or other localization tasks. For example, the localizer application 130 may allow the location or other presentation of the control to be changed to allow for localization of the facsimile form. These changes in presentation may be stored in any suitable format such as in a data store or metadata. For example, as shown in FIG. 2, the translated labels and modified presentation of each control may be modified in the localization application 130 and stored in any suitable data store or metadata, including a resource file storing MAPI properties in the metadata associated with the localized facsimile form. More specifically if the facsimile form is a Windows Form, the modifications to the facsimile form may be stored in a localized resource file and/or in a satellite dynamic link library file (“.dll” file).

To facilitate debugging and/or testing of the localized form, the localizer may also translate the descriptive name property of the binding by modifying the entity attribute map 112, and forming a localized entity attribute map associated with the localized facsimile form. The localized entity attribute map may take any format such as a database stored on a SQL server or metadata associated with the localized facsimile form. For example, as shown in FIG. 2, a first localized entity attribute map 144 may be associated with localized facsimile form 140, and a second entity attribute map 146 may be associated with the localized facsimile form 142.

Custom Form Generator

The localizer may then communicate the localized facsimile form (and associated metadata) and the localized entity attribute map to a custom form generator 150 as shown in FIG. 2. The custom form generator 150 generates a localized OUTLOOK form 160 based on the localized facsimile form 140, and generates a localized OUTLOOK form 162 based on the localized facsimile form 142. Localized OUTLOOK forms 160, 162 are compatible with the OUTLOOK workgroup personal information management program. In one example, the custom form generator may generate an OUTLOOK form template which is in the .oft format, although it should be recognized that any suitable format recognizable by the OUTLOOK program may be suitable. In the case where the facsimile form 112 does not need to be localized (e.g., the facsimile form is in the language desired for the final form), the custom form generator may receive the facsimile form 110 and entity attribute map 112 as the localized form 140 and localized entity attribute map 144.

Based on the OUTLOOK indicator and other metadata associated with the localized facsimile form 140, the custom form generator 150 may compare the localized facsimile form and the localized basis OUTLOOK form. The comparison may facilitate the custom form generator to generate a localized custom OUTLOOK form 160 in an OUTLOOK compatible format.

To generate the localized OUTLOOK form, the custom form generator 150 may receive a localized facsimile form 140, 142 as a Windows Form template with its associated metadata (such as in a satellite .dll file) and its associated localized entity attribute map 144, 146. The custom form generator may also receive an existing localized OUTLOOK form, or basis OUTLOOK form 172, 174, that is to be the basis or default for the new customized and localized OUTLOOK form 162. The basis OUTLOOK form may be any standard, default or customized form in an OUTLOOK compatible format. For example, the basis OUTLOOK form may be the default OUTLOOK form of any type including a post, contact, distribution list, task, appointment, meeting request, note and journal entry.

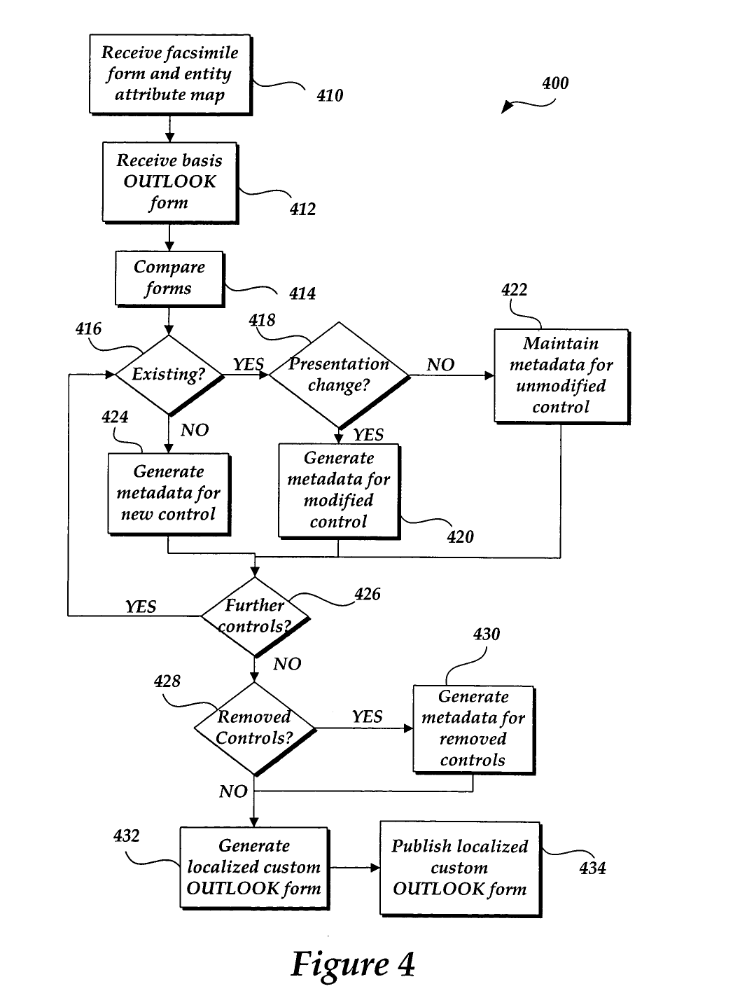

As shown in the flow chart of FIG. 4, the custom form generator 150 may generate a localized OUTLOOK form based on the localized facsimile form with its customized controls with a process 400. More particularly, the custom form generator may receive 410 a first localized facsimile form 140 and its associated entity attribute map 144 from the localizer (or from the application development environment 120 if no localization is required).

The custom form generator may also receive 412 a basis OUTLOOK form. A manager of the custom form generator may provide the appropriate basis OUTLOOK form to the custom form generator, or alternatively, the custom form generator may access a database and retrieve the basis OUTLOOK form. For example, metadata, such as the form properties stored in the .dll file may indicate and/or identify the actual basis OUTLOOK form to be retrieved by the custom form generator. Additionally or alternatively, the metadata or resource file associated with the localized facsimile form may indicate a type of default form, e.g., contact form, email form, and the like, to be used as the basis OUTLOOK form to be retrieved. Returning to FIG. 2, the basis OUTLOOK form 170 is localized to the same language, culture, customs as the localized facsimile form 140, and the basis OUTLOOK form 172 is localized to the same language, culture, custom as the localized facsimile form 142. Accordingly, the metadata associated with the localized facsimile form may indicate the type of OUTLOOK form to be retrieved, and the language/culture to be retrieved. In one example, the metadata associated with the localized facsimile form may include an OUTLOOK form indicator and a localization indicator indicating that the custom form generator should retrieve the default localized OUTLOOK form of an identified type with an identified localization content. The OUTLOOK type indicator may be the same for both facsimile forms 140 and 142, however, the localization indicator may be different depending on the localization of each facsimile form.

As an example, the basis OUTLOOK form 170 may be the contact form if localizing a custom business contact or account form. Similarly, the default task OUTLOOK form may be used as the basis OUTLOOK form for a customized business opportunity form. Moreover, the default journal OUTLOOK form may be used as the basis OUTLOOK form 170 when localizing a custom business notes form, a business journal form, and a phone message form.

Returning to the process illustrated in FIG. 4, the custom form generator may then compare 414 the received localized facsimile form and the localized basis OUTLOOK form. More particularly, the custom form generator may examine the metadata of the localized facsimile form, such as the satellite .dll file, and determine 416 which controls of the localized facsimile form exist in the basis OUTLOOK form. For example, the facsimile form 110 shown in FIG. 3 (which is localized to American English) may be compared to the basis OUTLOOK form 170 shown in FIG. 5. After examination of the localized facsimile form metadata, it should be apparent that the email control 330 ‘exists’ in the basis OUTLOOK form 170.

If the control of the facsimile form exists in the basis OUTLOOK form, then the custom form generator may determine 418 if the presentation of that control has changed as compared to the basis OUTLOOK form. More particularly, the custom form generator may compare the properties of the basis OUTLOOK form control with the properties of the facsimile form control and determine how the control has changed. For example, in comparing the email control of the facsimile form of FIG. 3 with the email control 520 of the basis OUTLOOK form of FIG. 5, it should be appreciated that the position of the control 520 has changed as well as the appearance of the control.

If the presentation has been modified as shown in FIG. 4, the custom form generator may generate 420 metadata to be associated with the customized OUTLOOK form 160 which indicates how the control has been modified. The modification metadata may be stored in any suitable format, such as a MAPI property in a resource file, and may be associated with the corresponding control. If the presentation or other property of the control has not been modified, then the custom form generator may generate metadata for that control or maintain 422 that control within the basis OUTLOOK form.

If the control of the facsimile form does not exist in the basis OUTLOOK form, the custom form generator may generate 424 the metadata necessary to create the control. For example, in comparing the facsimile form 110 of FIG. 3 with the basis OUTLOOK form of FIG. 5, it should be appreciated that the nickname field 310, although an available OUTLOOK field, does not exist in the basis OUTLOOK form illustrated in FIG. 5. Accordingly, the custom form generator may generate or verify the metadata based upon the information in the metadata associated the form and/or with the entity attribute map to ensure the control is properly described and supported. To generate the control in the basis OUTLOOK form, the custom form generator may access the OUTLOOK application design environment and/or may generate the appropriate code in the .oft format. It should also be appreciated that neither the friend control 330 nor the foe control 340 of the facsimile form 110 exist within the basis OUTLOOK form, nor are they available controls from the Field Selector in the OUTLOOK design environment. Consequently, the custom form generator may generate or verify the metadata based upon the information in the facsimile form metadata and/or the entity attribute map 144 to ensure the control and the new underlying field are properly described and/or supported. To generate the control in the basis OUTLOOK form, the custom form generator may access the OUTLOOK application design environment and/or may generate the appropriate code in the .oft format. The metadata regarding the new controls and the existing controls may be stored in any suitable data store, such as a resource file, and stored in any suitable database, such as a SQL database server.

To ensure the controls added to the basis OUTLOOK form are properly bound, the custom form generator may access the binding identifier in the localized facsimile form metadata, and map the added control to the correct named field based on the association stored in the localized entity attribute map. For example, as noted above, the control may be bound to a field 110, and the entity attribute map 112 may associate the identifier 110 with the $foobar$ descriptive named field. The item descriptive name, $foobar$ may be localized in the localized entity attribute map 140 as $$foo$bar$$. The custom form generator may map the binding identifiers of the form metadata with the binding fields named in the localized entity attribute map. In this manner, the entity attribute map may centralize the changes to bindings, and may coordinate control bindings. For example, examination of the entity attribute map may indicate that a particular field name has already been used and bound to an existing control, and consequently, the new control binding may be named with a non-conflicting name.

The custom form generator may determine 426 if further controls need to be compared and/or have associated metadata generated. More particularly, the custom form generator may repeat the above comparison steps 416-426 for each control of the facsimile form to ensure that those controls are fully supported by the MAPI properties in the metadata and associated localized entity attribute map.

The custom form generator may also determine 428 if a control of the basis OUTLOOK form no longer exists in the localized facsimile form and generate 430 the associated metadata indicating removal of the control. For example, comparing the facsimile form 110 of FIG. 3 and the basis OUTLOOK form 170 of FIG. 5, it should be appreciated that several controls no longer exist in the customized facsimile form 110. More particularly, the name control 530, the job title control 540, the company control 550, the address control 560, are not present in the facsimile form 110 of FIG. 3. Accordingly, the custom form generator may generate 430 the appropriate metadata to indicate removal of those controls, and store that information in any suitable format.

In one example, the custom form generator may compare the metadata of a localized facsimile form 140 and the basis localized OUTLOOK form to determine if the facsimile form has added, removed or renamed any of the tabbed pages of the basis OUTLOOK form. For each tabbed page, the custom form generator may determine if there are any new controls, removed controls and/or repositioned modified controls of the localized facsimile form as compared to the localized basis OUTLOOK form.

Returning to FIG. 4, the custom form generator may then generate 432 the new localized and customized OUTLOOK form 160 based upon the new metadata of the basis OUTLOOK form which has been modified with the metadata of the localized facsimile form and the localized entity attribute map. The custom form generator 150 may generate the customized OUTLOOK form 160 ab initio by generating the appropriate VBScript to generate an OUTLOOK form or may interface with the OUTLOOK form design environment to generate the localized custom form. Alternatively, the custom form generator may modify the basis OUTLOOK form and ‘save as’ a new localized and custom form 160. The above process may be completed for each localized facsimile form, such as form 142 to generate the desired localized OUTLOOK form 162.

As a result, the history of the localization of the OUTLOOK form is maintained in the information stored in the different entity attribute maps, e.g., entity attribute map 112 associated with the facsimile form and the localized entity attribute map 144, 146 associated with the localized facsimile form 140, 142 respectively. With this information, changes to the localized custom OUTLOOK form are fairly straightforward, and may even be reduced to a single click after the form is translated by the localizer. More particularly, to modify a localized custom OUTLOOK form, the localizer may translate and modify the initial localized facsimile form 140 and associated entity attribute map 144 within the localizer application 130. The modified localized facsimile form and entity attribute map may then be communicated to the custom form generator and compared either to the original basis OUTLOOK form 170, or alternatively, may be compared to the previous version of the localized custom OUTLOOK form.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer readable medium having computer-executable components comprising:
(a) an application development environment component constructed to allow a user to generate a facsimile form comprising a plurality of controls which have a look and feel of a basis OUTLOOK form;
(b) a data store component constructed to store an existence OUTLOOK indicator for each control indicating whether the control exists in a basis localized OUTLOOK form;
(c) an entity attribute map constructed to associate a binding identifier with an item field descriptive name;
(d) a custom form generator constructed to receive a version of the facsimile form, a version of the entity attribute map, a version of the data store, and the basis localized OUTLOOK form, the custom form generator generating a custom localized OUTLOOK form based upon the version of the facsimile form.

2. The computer readable medium of claim 1, further comprising a form localizer tool constructed to allow a user to modify at least one control to create the version of the facsimile template.

3. The computer readable medium of claim 2, wherein the form localizer tool is constructed to allow a user to modify the item field descriptive name to form the version of the entity attribute map.

4. The computer readable medium of claim 1, wherein the facsimile form is a Windows Form.

5. The computer readable medium of claim 1, wherein the custom OUTLOOK form is in a .oft format.

6. The computer readable medium of claim 1, wherein the data store is a resource file associated with the facsimile form.

7. The computer readable medium of claim 1, wherein, based on the existence OUTLOOK indicator, the custom form generator is constructed to determine which controls of the facsimile form exist in the basis OUTLOOK form and determine which of the existing controls have a modified presentation.

8. The computer readable medium of claim 7, wherein the custom form generator is constructed to bind a selected existing control with a selected item field descriptive name in the entity attribute map.

9. The computer readable medium of claim 1, wherein based on the existence OUTLOOK indicator, the custom form generator is constructed to determine which controls of the facsimile form are new compared to the basis OUTLOOK form.

10. The computer readable medium of claim 9, wherein the custom form generator is constructed to bind a selected new control with a selected item field descriptive name in the entity attribute map.

11. A method comprising the steps of:
(a) generating a facsimile form comprising a plurality of controls having the appearance of an Outlook form;
(b) associating a binding identifier of at least one control of the facsimile form with an item field descriptive name in an entity attribute map;
(c) for each control of the plurality of controls, storing in a data store, an indicator whether the control exists in a predetermined localized OUTLOOK form;
(d) localizing the facsimile form;
(e) generating metadata indicating which existing controls of the predetermined localized OUTLOOK form have a modified presentation in the localized facsimile form, and which controls of the localized facsimile form do not exist in the predetermined localized OUTLOOK form.
(f) generating a custom localized OUTLOOK form based upon the metadata.

12. The method of claim 11, wherein localizing the facsimile form comprises localizing the item field descriptive name of the entity attribute map.

13. The method of claim 11, wherein generating the custom localized OUTLOOK form comprises binding at least one of the plurality of controls to the item field descriptive name.

14. The method of claim 13, wherein generating the custom localized OUTLOOK form comprises modifying the predetermined localized OUTLOOK form with the metadata and the binding of the at least one of the plurality of controls.

15. The method of claim 11, wherein the facsimile form is a Windows Form template.

16. The method of claim 11, wherein the custom form localized OUTLOOK form is in a .oft format.

17. The method of claim 11, wherein the data store is a resource file associated with the localized facsimile form.

18. A computer readable medium having computer-executable instructions for performing steps comprising:
(a) generating a Windows Form template comprising a plurality of controls having the appearance of an OUTLOOK form;
(b) associating a binding identifier of at least one control of the Windows Form template with an item field descriptive name in an entity attribute map;
(c) for each control of the plurality of controls, storing in a resource file, an indicator whether the control exists in a predetermined localized OUTLOOK form.

19. The computer readable medium of claim 18, further comprising localizing the plurality of controls of the Windows Form template.

20. The computer readable medium of claim 19, further comprising localizing each item field descriptive name.

21. The computer readable medium of claim 18, further comprising modifying the predetermined localized OUTLOOK form based on the plurality of controls of the Windows Form template.

22. The computer readable medium of claim 21, wherein modifying the predetermined localized OUTLOOK form comprises determining which of the plurality of controls exists in the predetermined localized OUTLOOK form and modifying the predetermined localized OUTLOOK form to have the same appearance as the existing controls.

23. The computer readable medium of claim 21, wherein modifying the predetermined localized OUTLOOK form comprises determining which of the plurality of controls are new and do not exist in the predetermined localized OUTLOOK form and modifying the predetermined localized OUTLOOK form to have the new controls.

24. A method comprising the steps of:
(a) generating a first metadata indicating a first control of a localized facsimile form as existing as a first basis control in a localized basis OUTLOOK form;
(b) generating a second metadata indicating a second control of the localized facsimile form as not existing as a basis control in the localized basis OUTLOOK form;
(c) generating an entity attribute map associating a binding identifier of the second control with a first item field descriptive name; and
(d) generating a custom localized OUTLOOK form based on the first metadata, the second metadata, and the entity attribute map.

25. The method of claim 24, wherein generating the custom localized OUTLOOK form comprises determining if the first metadata differs from metadata associated with the first basis control.

26. The method of claim 24, wherein generating the custom localized OUTLOOK form comprises modifying metadata associated with the localized basis OUTLOOK form with the first metadata, the second metadata, and the item field descriptive name.

27. The method of claim 26, wherein modifying the metadata comprises modifying the presentation of the first basis control.

28. The method of claim 26, wherein modifying the metadata comprises adding a second control to the localized basis OUTLOOK form having the same look and feel of the second control.

29. The method of claim 24, wherein the facsimile form is a Windows Form template.

30. The method of claim 24, wherein generating the entity attribute map comprises associating a binding identifier of the first control with an other item filed descriptive name.
